(19) United States
(12) Patent Application Publication
(10) Pub. No.: US 2018/0266067 A1
(43) Pub. Date: Sep. 20, 2018

(54) Water Gate

(71) Applicant: Elias Salim Hajjar, Sydney (AU)

(72) Inventor: Elias Salim Hajjar, Sydney (AU)

(21) Appl. No.: 15/381,419

(22) Filed: Dec. 16, 2016

Related U.S. Application Data
(63) Continuation of application No. PCT/AU2015/000355, filed on Jun. 16, 2015.

(30) Foreign Application Priority Data
Jun. 16, 2014 (AU) 2014902304

(51) Int. Cl. E02B 7/44; E02B 7/36; E02B 7/54

(52) U.S. Cl. CPC E02B 7/44; E02B 7/36; E05Y 2800/12; E05Y 2900/40; E05Y 2600/31; E02B 7/54

(57) ABSTRACT

A water gate comprising at least one curved surface, the curved surface extending laterally between two sides; at least one web extending between the two sides of the curved surface.

### BACKGROUND

The disclosure relates to structures for support, construction or water management and particularly to water gates or penstock gates for controlling the flow of water. The structure is described particularly in relation to water gates. However, it will be clear to a person skilled in the art that the structure can be utilised for alternative support or construction applications such as beams, roofs, and bridge members, and in alternative water control settings.

### SUMMARY

Disclosed in some forms is a water gate comprising two sides and two gate surfaces extending between the two sides, the gate surfaces being in a facing arrangement with one another and arranged such that they meet at least at one side and are spaced apart from one another at a location between the two sides.

In some forms the gate surface comprises a front surface that is generally concave.

In some forms the two surfaces define an internal cavity.

Disclosed in some forms is a water gate, comprising at least one curved surface, the curved surface extending laterally between two sides; at least one web extending between the two sides of the curved surface.

The water gate of the present disclosure advantageously decreases labour and material for a water gate while maintaining the same strength and response to water pressure. This provides cost savings in transport, labour and material.

Disclosed in some forms is a water gate constructed by folding a single sheet to form two facing surfaces, the surfaces meeting at two sides and being spaced apart from one another between the two sides.

Disclosed too, is a process for forming a water gate from a single sheet, the process comprising:

a) folding the sheet to form a first gate surface having two sides and a flap extending from each side, each of the flaps having a longitudinal edge;
b) contacting the longitudinal edges together such that the two flaps form a second gate surface, at least a portion of the second gate surface being spaced apart from the first gate surface;
c) sealing the longitudinal edges together.

### BRIEF DESCRIPTION OF THE FIGURES

The embodiments will now be described in view of the Figures, in which,

FIG. 1 is a front view of a water gate of one embodiment of the disclosure;

FIG. 2 is a cross sectional view through A-A of the embodiment shown in FIG. 1;

FIG. 3 shows multiple possible cross sectional views of different embodiments of the water gate of the disclosure;

FIG. 4 shows a cross-sectional view of one embodiment of the disclosure;

FIG. 5 shows a cross-sectional view of one embodiment of the disclosure;

FIG. 6 shows a cross-sectional view of one embodiment of the disclosure;

FIG. 7 shows a cross-sectional view of one embodiment of the disclosure;

FIG. 8 shows a cross-sectional view of one embodiment of the disclosure;

FIG. 9 shows a cross-sectional view of one embodiment of the disclosure;

FIG. 10 shows a cross-sectional view of one embodiment of the disclosure;

FIG. 11 shows a perspective view of one embodiment of the disclosure;

FIG. 12 shows a perspective view of one embodiment of the disclosure.

### DETAILED DESCRIPTION OF EMBODIMENTS OF THE DISCLOSURE

Disclosed in some forms is a water gate comprising two sides and two gate surfaces extending between the two sides, the gate surfaces being in a facing arrangement with one another and arranged such that they meet at least at one side and are spaced apart from one another at a location between the two sides.

The water gate has the advantage of reducing costs of manufacture, material and transport. The material used is distributed distal from a centre-line of the water gate to effectively distribute stress.

In some forms at least one gate surface is arranged, in use, to constrain the flow of water.

In some forms the gate surfaces meet one another at both sides.

In some forms at least one gate surface is concave.

In some forms the two gate surfaces are further apart at a position centrally located between the two sides and closer together at a position proximal one of the two sides.

In some forms, the water gate is constructed of a single sheet folded to form two facing gate surfaces.

In some forms the sheet is folded to form a first gate surface and two flaps extending from either side of the first gate surface and wherein the two flaps are brought into contact at a joining position intermediate the two sides. In some forms the water gate is sealed at the joining position.

In some forms the water gate includes side regions located at each side of the water gate, the side regions including a section in which the two gate surfaces extend substantially parallel to and in contact with one another.

In some forms the two gate surfaces are attached to one another at the side regions. In some forms the two gate surfaces are attached by means of bolting. In some forms the two gate surfaces are attached by means of welding.

In some forms the two gate surfaces define an internal cavity.

In some forms the water gate further comprises reinforcement located in the internal cavity.

In some forms the body extends longitudinally between two ends and the reinforcement extends longitudinally.

In some forms at least a portion of the internal cavity is filled.

In some forms a portion of the internal cavity is filled with an incompressible material.

In some forms one of the gate surfaces includes at least one cavity.

In some forms one of the gate surfaces comprises a plurality of bands.

In some forms, the two gate surfaces comprise one substantially flat surface extending between the two sides and one concave surface in contact with the flat surface at the two sides and curving away from the flat surface to define an internal cavity between the two gate surfaces.

In a second aspect, disclosed is a method of controlling water flow comprising moveably positioning a water gate to constrain the flow of water.

In a third aspect, disclosed is a water gate constructed by folding a single sheet to form two facing surfaces, the surfaces meeting at two sides and being spaced apart from one another between the two sides.

In some forms the process of folding a single sheet comprises:

a) folding the sheet to form a first gate surface having two sides and a flap extending from each side;
b) contacting the two flaps together such that the two flaps form a second gate surface, at least a portion of the second gate surface being spaced apart from the first gate surface;
c) sealing the two flaps together.

In some forms the process comprises the step of forming side regions along the two sides, the side regions comprising a section in which the first gate surface and the second gate surface extend adjacent with one another.

In some forms the second gate surface is generally concave.

In some forms the sheet is stainless steel.

In a fourth aspect, disclosed is a process for forming a water gate from a single sheet, the process comprising:

a) folding the sheet to form a first gate surface having two sides and a flap extending from each side, each of the flaps having a longitudinal edge;
b) contacting the longitudinal edges together such that the two flaps form a second gate surface, at least a portion of the second gate surface being spaced apart from the first gate surface;
c) sealing the longitudinal edges together.

In some forms the process further comprises the step of forming side regions along the two sides, the side regions comprising a section in which the first gate surface and the second gate surface extend adjacent with one another.

In some forms the second gate surface is generally concave.

In some forms the step of folding forms an interior cavity.

In some forms the process further comprises positioning reinforcement within the internal cavity.

In a fourth aspect disclosed is a water gate comprised of a single sheet of material, folded to form two surfaces in facing relationship to one another.

In some forms, disclosed is a water gate comprising:

at least one curved surface, the curved surface extending laterally between two sides;
at least one web extending between the two sides of the curved surface.

In some forms the web comprises at least one band of material.

In some forms the web comprises a sheet.

In some forms the web is composed of the same material as the curved surface.

In some forms the web prevents movement of the two sides away from one another.

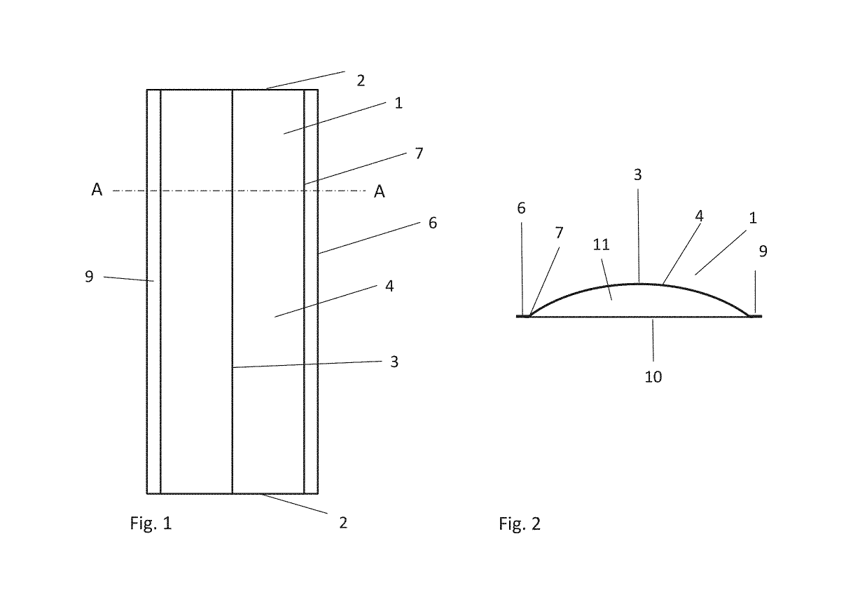

Referring to FIG. 1, disclosed is a structure in the form of a water gate 1 comprising a body extending between two ends 2. In the illustrated form, the body comprises sheet material which, in some forms is stainless steel or other foldable, malleable, strong metal or polymer sheet.

In some forms, the body comprises a single sheet of sheet material which is folded to form the water gate.

Generally speaking, water gates have utilised a flat surface and stiffeners extending laterally across the flat surface to provide reinforcement to the flat surface for meeting the water pressure requirements of a water gate. This can require multiple parts which are joined together and adds weight and labour costs to production of the water gates. The present disclosure allows for a simpler construction while in some forms providing the same or greater resistance to water pressure. In some forms, the weight saving is upwards of 20%. There are also cost savings in transportation and labour and materials.

The water gate 1 comprises two gate surfaces. In FIG. 1 only the front surface is shown. The front surface 4, comprises two flaps sealed along a center line 3, to form the front gate surface 4. The front gate surface 4 extends between two sides 6 and is turned out of plane at fold line 7. The front surface 4, therefore also includes two side regions 9.

As can best be seen in FIG. 2, which is a cross sectional view of the embodiment of FIG. 1, the water gate 1 includes two gate surfaces, a front surface 4 and a rear surface 10. The surfaces meet at the sides 6 of the gate 1 and extend between its ends. In the illustrated form, the rear surface 10 is essentially a flat surface. The front surface 4 extends along the rear surface 10 for a side region 9 and then turns away from the rear surface 10 to form a concave front surface. This defines an interior cavity 11 which is located between and defined by the front surface 4 and the rear surface 10.

The gate surfaces 4 and 9 are attached together at side regions 9 in the illustrated form. In some forms this attachment comprises welding or bolting the surfaces together in the side region 9.

The water gate 1 further includes a centrally located seal 3 extending longitudinally along the water gate 1. In this illustrated form, the water gate 1 is composed of a single sheet of sheet material such as stainless steel. The single sheet is folded at sides 6 to form rear surface 10. The sheet is then bent at score lines 7 and curves away from rear surface 10. Seal line 3 is sealed to form front surface 4 which is generally curved or concave in shape.

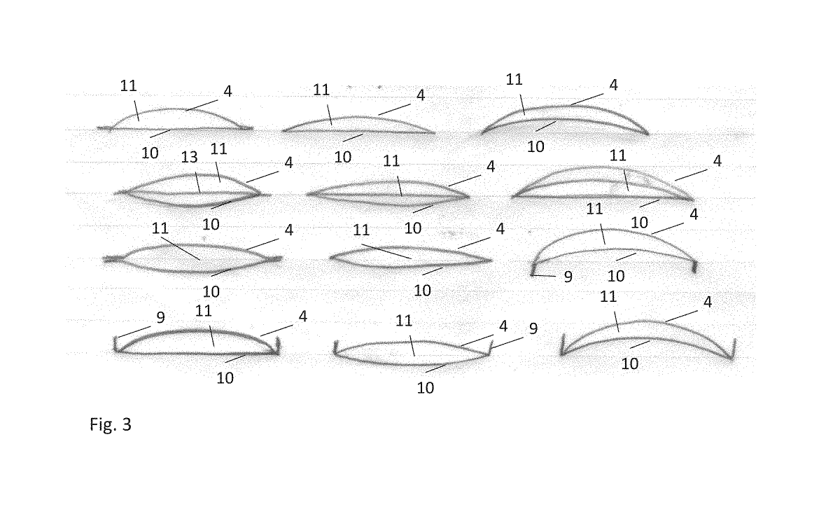

FIG. 3 shows multiple versions of potential cross sections of the water gate. In these embodiments, the rear surface 10 is sometimes flat, and sometimes curved. The front surface 4 is always curved. The side regions 9 extend outwardly, forwardly or rearwardly with respect to the water gate. As shown in this Fig., the internal cavity 11 can include a further gate surface 13 which extends therethrough.

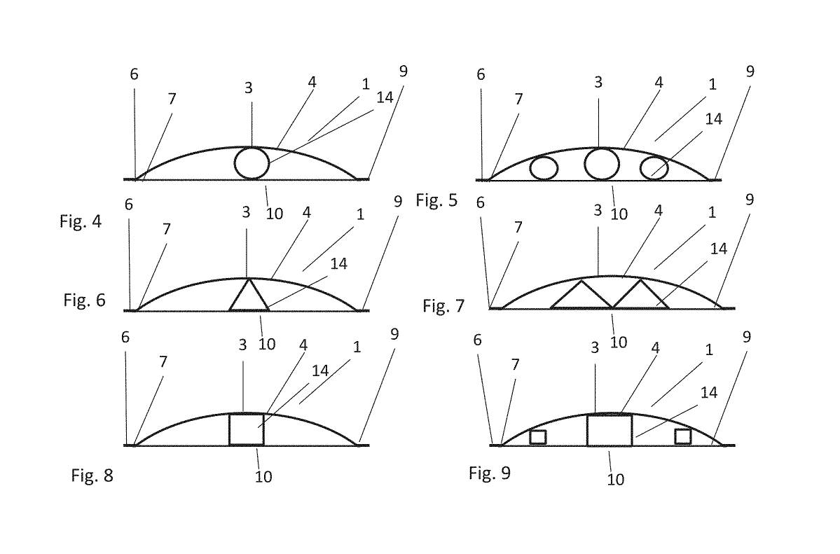

Referring now to FIGS. 4 through 9, in some forms the water gate 1 includes internal reinforcement 14 which is positioned within the internal cavity 11 between the front gate surface 4 and the rear gate surface 10. This reinforcement provides additional strength without increasing the weight dramatically.

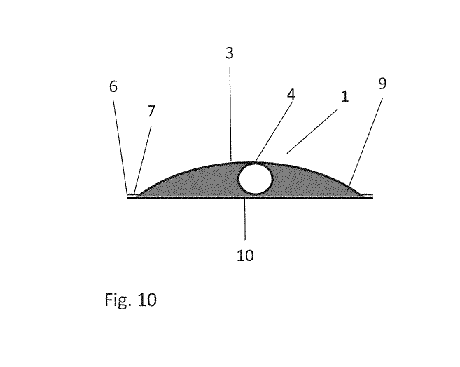

FIGS. 4 and 5 show tubular reinforcements extending longitudinally through the water gate 1. FIGS. 6 and 7 show triangular reinforcement extending longitudinally through the water gate 1. And FIGS. 8 and 10 show rectangular reinforcement extending longitudinally through the water gate 1. This reinforcement can be utilised regardless of the external shape of the water gate.

As shown in FIG. 10, any one of the cross sectional versions of the water gate can be completely or partially filled with a material such as foam or other incompressible material to strengthen the water gate without adding significant weight.

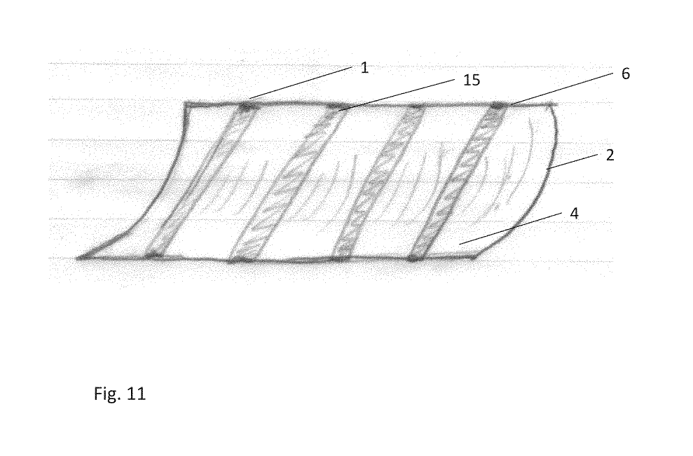

As shown in FIG. 11, in some illustrated forms the water gate 1 comprises a gate surface 4 which is curved outwardly. The surface extends between upper and lower edges 2 and between 2 sides 6. A web 15 in the form of a plurality of bands extends between the two sides 6 to prevent the sides from moving away from one another under pressure.

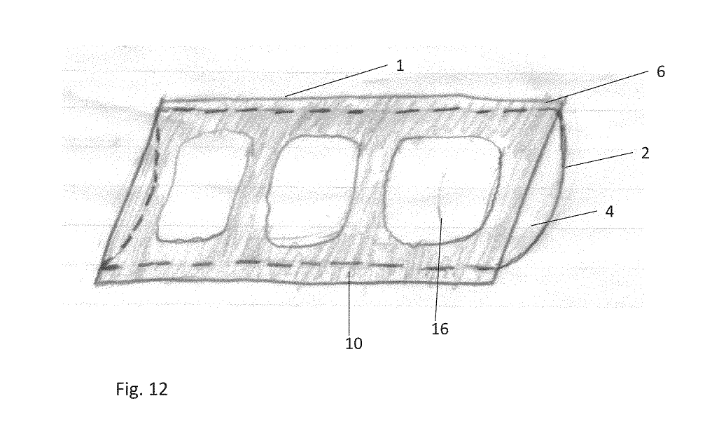

As shown in FIG. 12, in some illustrated forms the water gate 1 comprises two gate surfaces 4 and 10 in a facing relationship with one another. Gate front surface 4 is generally concave and extends between two sides 6 at which point front surface 4 contacts rear surface 10. Rear surface 10 includes a plurality of cut-outs 16.

While the structure has been described in terms of water gates, it can be utilised for other constructions.

The water gate is retrofittable to existing water gate systems.

It is to be understood that, if any prior art publication is referred to herein, such reference does not constitute an admission that the publication forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A water gate comprising:
a gate body, the body having two sides and two gate surfaces extending between the two sides, the gate surfaces being in a facing arrangement with one another and arranged such that they meet at least at one side and are spaced apart from one another at a location between the two sides.

2. A water gate as defined in claim 1, wherein at least one gate surface is arranged, in use, to constrain the flow of water.

3. A water gate as defined in claim 1 or 2, wherein the gate surfaces meet one another at both sides.

4. A water gate as defined in any of the preceding claims, wherein at least one gate surface is concave.

5. A water gate as defined in any of the preceding claims, wherein the two gate surfaces are further apart at a position centrally located between the two sides and closer together at a position proximal one of the two sides.

6. A water gate as defined in any of the preceding claims, the water gate being constructed of a single sheet folded to form two facing gate surfaces.

7. A water gate as defined in claim 6, wherein the sheet is folded to form a first gate surface and two flaps extending from either side of the first gate surface and wherein the two flaps are brought into contact at a joining position intermediate the two sides.

8. A water gate as defined in claim 7, wherein the water gate is sealed at the joining position.

9. A water gate as defined in any of the preceding claims, the water gate including side regions located at each side of the water gate, the side regions including a section in which the two gate surfaces extend substantially parallel to and in contact with one another.

10. A water gate as defined in claim 9, wherein the two gate surfaces are attached at the side regions.

11. A water gate as defined in claim 10, wherein the two gate surfaces are attached by means of bolting.

12. A water gate as defined in claim 10, wherein the two gate surfaces are attached by means of welding.

13. A water gate as defined in any of the preceding claims, wherein the two gate surfaces define an internal cavity.

14. A water gate as defined in claim 13, further comprising reinforcement located in the internal cavity.

15. A water gate as defined in claim 14, wherein body extends longitudinally between two ends and the reinforcement extends longitudinally.

16. A water gate as defined in any one of claims 13 to 15, wherein at least a portion of the internal cavity is filled.

17. A water gate as defined in claim 16, wherein a portion of the internal cavity is filled with an incompressible material.

18. A water gate as defined in any of the preceding claims, wherein one of the gate surfaces includes at least one cavity.

19. A water gate as defined in any of the preceding claims, wherein one of the gate surfaces comprises a plurality of bands.

20. A water gate as defined in any of the preceding claims, the two gate surfaces comprising one substantially flat surface extending between the two sides and one concave surface in contact with the flat surface at the two sides and curving away from the flat surface to define an internal cavity between the two gate surfaces.

21. A method of controlling water flow comprising moveably positioning a water gate as defined in any of the preceding claims to constrain the flow of water.

22. A water gate constructed by folding a single sheet to form two facing surfaces, the surfaces meeting at two sides and being spaced apart from one another between the two sides.

23. A water gate as defined in claim 22, wherein the process of folding a single sheet comprises:
a) folding the sheet to form a first gate surface having two sides and a flap extending from each side;
b) contacting the two flaps together such that the two flaps form a second gate surface, at least a portion of the second gate surface being spaced apart from the first gate surface;
c) sealing the two flaps together.

24. A water gate as defined in claim 23, further comprising the step of forming side regions along the two sides, the side regions comprising a section in which the first gate surface and the second gate surface extend adjacent with one another.

25. A water gate as defined in claim 23 or 24, wherein the second gate surface is generally concave.

26. A water gate as defined in any one of claims 23 to 25, wherein the sheet is stainless steel.

27. A process for forming a water gate from a single sheet, the process comprising:
a) folding the sheet to form a first gate surface having two sides and a flap extending from each side, each of the flaps having a longitudinal edge;
b) contacting the longitudinal edges together such that the two flaps form a second gate surface, at least a portion of the second gate surface being spaced apart from the first gate surface;
c) sealing the longitudinal edges together.

28. A process as defined in claim 27, further comprising the step of forming side regions along the two sides, the side regions comprising a section in which the first gate surface and the second gate surface extend adjacent with one another.

29. A process as defined in claim 27 or 28, wherein the second gate surface is generally concave.

30. A process as defined in any one of claims 27 to 29, wherein the sheet is stainless steel.

31. A process as defined in any one of claims 27 to 30, wherein the step of folding forms an interior cavity.

32. A process as defined in claim 31, further comprising positioning reinforcement within the internal cavity.

33. A water gate comprised of a single sheet of material, folded to form two surfaces in facing relationship to one another.

34. A water gate as defined in claim 33, wherein the material is stainless steel.

35. A water gate comprising:
at least one curved surface, the curved surface extending laterally between two sides;
at least one web extending between the two sides of the curved surface.

36. A water gate as defined in claim 35, wherein the web comprises at least one strap.

37. A water gate as defined in claim 35, wherein the web comprises a sheet.

38. A water gate as defined in any one of claims 35 to 37, wherein the web prevents movement of the two sides away from one another.
